(19) United States
(12) Patent Application Publication
(10) Pub. No.: US 2010/0108605 A1
(43) Pub. Date: May 6, 2010

(54) Ethanol stable polyether imide membrane for aromatics separation

(76) Inventors: Abhimanyu O. Patil, Westfield, NJ (US); Timothy D. Shaffer, Hackettstown, NJ (US); Satish Bodige, Wayne, NJ (US); David C. Dalrymple, Bloomsbury, NJ (US); Benjamin A. McCool, Bonita Springs, FL (US); Randall D. Partridge, Califon, NJ (US)

Correspondence Address: ExxonMobil Research and Engineering Company, P. O. Box 900, Annandale, NJ, 08801-0900, US

(21) Appl. No.: 12/589,676

(22) Filed: Oct. 27, 2009

Related U.S. Application Data
(60) Provisional application No. 61/198,240, filed on Nov. 4, 2008.

(51) Int. Cl. B01D 61/02; B01D 61/36

(52) U.S. Cl. 210/643; 210/500.37; 210/483

(57) ABSTRACT

The present invention relates to a polymeric aromatic selective membrane comprising an cross linked polyether imide membrane that comprise the reaction of a polyether amine with an dianhydride, and that may be utilized in a process for selectively separating aromatics from a hydrocarbon feedstream comprised of aromatic and aliphatic hydrocarbons and at least one alcohol, typically ethanol.

This application claims the benefit of U.S. Provisional Application No. 61/198,240 filed Nov. 4, 2008.

### FIELD OF THE INVENTION

This invention relates to a polymeric membrane composition that exhibits stability in the presence of alcohol, a method of making the polymeric membrane, and a process for separating components of a hydrocarbon feedstream including a hydrocarbon feedstream containing at least one alcohol. More particularly, but not by way of limitation, this invention relates to the polymeric membrane composition and its use in a process for the separation of aromatics from a hydrocarbon feedstream containing aromatics and aliphatic compounds and at least one alcohol, typically ethanol.

### BACKGROUND OF THE INVENTION

Polymeric membrane based separation processes such as reverse osmosis, pervaporation and perstraction are known in the art. In the pervaporation process, a desired feed component, e.g., an aromatic component, of a liquid and/or vapor feed is preferentially absorbed by the membrane. The membrane is typically exposed at one side to a stream comprised of a mixture of liquid feeds, and a vacuum is typically applied to the membrane at the opposite side so that the adsorbed component migrates through the membrane and is removed as a vapor from the opposite side of the membrane via a solution-diffusion mechanism. A concentration gradient driving force is established to selectively pass the desired components through the membrane from its feed or upstream side to its permeate or downstream side.

The perstraction process may also be used to separate a liquid stream into separate products. In this process, the driving mechanism for the separation of the stream into separate products is provided by a concentration gradient exerted across the membrane. Certain components of the fluid will preferentially migrate across the membrane because of the physical and compositional properties of both the membrane and the process fluid, and will be collected on the other side of the membrane as a permeate. Other components of the process fluid will not preferentially migrate across the membrane and will be swept away from the membrane area as a retentate stream. Due to the pressure mechanism of the perstraction separation, it is not necessary that the permeate be extracted in the vapor phase. Therefore, no vacuum is required on the downstream (permeate) side of the membrane and permeate emerges from the downstream side of the membrane in the liquid phase. Typically, permeate is carried away from the membrane via a sweep liquid.

The economic basis for performing such separations is that the two products achieved through this separation process (i.e., retentate and permeate) have a refined value greater than the value of the unseparated feedstream. Membrane technology based separations can provide a cost effective processing alternative for performing the product separation of such feedstreams. Conventional separation processes such as distillation and solvent extraction can be costly to install and operate in comparison with membrane process alternatives. These conventional based processes can require a significant amount of engineering, hardware and construction costs to install and also may require high operational and maintenance costs. Additionally, most of these processes require substantial heating of the process streams to relatively high temperatures in order to separate different components during the processing steps resulting in higher energy costs than are generally required by low-energy membrane separation processes.

A major obstacle to commercial viability of membrane separation technologies, particularly for hydrocarbon feeds, is to improve the flux and selectivity while maintaining or improving the physical integrity of current membrane systems. Additionally, the membrane compositions need to withstand the myriad of applications feed constituents, including alcohols.

Numerous polymeric membrane compositions have been developed over the years. Such compositions include polyurea/urethane membranes (U.S. Pat. No. 4,914,064); polyurethane imide membranes (U.S. Pat. No. 4,929,358); polyester to imide copolymer membranes (U.S. Pat. No. 4,946,594); polyimide aliphatic polyester copolymer membranes (U.S. Pat. No. 4,990,275); and diepoxyoctane crosslinked/esterified polyimide/polyadipate copolymer (diepoxyoctane PEI) membranes (U.S. Pat. No. 5,550,199).

Another obstacle is the presence of alcohol in the feedstream, an increasingly frequent issue with government mandates and other incentives for adding alcohols to conventional hydrocarbon based fuels. Conventional polymer membranes suffer from instability in the presence of even small amounts of alcohol in the membrane feedstream. The present invention solves this problem.

Therefore there is a need in the industry for new membrane compositions with improved stability in processing alcohol containing feeds. There is also a need in the industry for new membrane compositions having high flux and selectivity for separating aromatics.

### SUMMARY OF THE INVENTION

The present invention relates to a polymeric aromatic selective membrane comprising a cross linked polyether imide, a method of making the polymeric membrane, and a process for separating components of a feedstream utilizing the polymeric membrane. In particular, the polymeric membrane of the present invention may be utilized in a process for selectively separating aromatics from a hydrocarbon feedstream comprised of aromatic and aliphatic hydrocarbons and at least one alcohol, typically ethanol.

In one embodiment, the present invention relates to the composition of a polymeric membrane effective in selectively separating components of a hydrocarbon feedstream. In particular, the present invention relates to the composition of a polymeric membrane effective in the selective separation of aromatics from a hydrocarbon stream containing aromatics and non-aromatics and at least one alcohol.

This invention results in a membrane composition with improved membrane physical integrity when used in an alcohol containing environment.

In one embodiment, the present invention relates to a membrane comprising polyether amines such as polyethylene oxide (“PEO”), polypropylene oxide (“PPO”), or a combination of PEO and PPO co-polymers and/or multi-amine group terminated polyethers reacted with an dianhydride and, fabricated into thin film membranes.

In a preferred embodiment, the membrane composition is stable for feeds containing twenty percent (20%) or higher alcohol content.

### BRIEF DESCRIPTION OF THE DRAWINGS

FIG. 1 illustrates a simple embodiment of the present invention.

FIG. 2 illustrates the effect of temperature on flux and permeate composition. Flux increases with temperature.

### DETAILED DESCRIPTION OF THE PREFERRED EMBODIMENTS

As used herein, the term “hydrocarbon” means an organic compound having a predominantly hydrocarbon character. Accordingly, organic compounds containing one or more non-hydrocarbon radicals (e.g., sulfur or oxygen) would be within the scope of this definition. As used herein, the terms “aromatic hydrocarbon” or “aromatic” means a hydrocarbon-based organic compound containing at least one aromatic ring. The rings may be fused, bridged, or a combination of fused and bridged. In a preferred embodiment, the aromatic species separated from the hydrocarbon feed contains one or two aromatic rings. The terms “non-aromatic hydrocarbon” or “non-aromatic” or “saturate” means a hydrocarbon-based organic compound having no aromatic cores. The terms “non-aromatics” and “aliphatics” are used interchangeably in this document.

Also as used herein, the terms “thermally cross-linked” or “thermal cross-linking” means a membrane curing process at curing temperatures typically above about 25 to about 400° C. (77 to 572° F.).

Also as used herein, the term “selectivity” means the ratio of the desired component(s) in the permeate to the non-desired component(s) in the permeate divided by the ratio of the desired component(s) in the feedstream to the non-desired component(s) in the feedstream. The term “flux” or “normalized flux” is defined the mass rate of flow of the permeate across a membrane usually in dimensions of Kg/m²-day, Kg/m²-hr, Kg-μm/m²-day, g-μm/m²-sec, or Kg-μm/m²-hr.

Also used herein, the term “selective” means that the described part has a tendency to allow one or more specific components of the feedstream to preferentially pass through that part with respect to the other feedstream components. Selectivity for the membranes of the present invention are greater than about 3.0, preferably greater than about 4.0, and most preferably greater than about 5.0.

We have found that polyetheramines containing polyethylene oxide (PEO), polypropylene oxide (PPO) or combination of PEO/PPO copolymers can be reacted with dianhydrides, or functional dianhydrides, and the material can be fabricated into membranes. The membranes display superior separations performance and show good membrane durability with ethanol and ethanol containing gasoline fuels.

The dianhydride can be pyromellitic dianhydride (PMDA), 3,3′,4,4′-biphenyltetracarboxylic dianhydride, 4,4′-(Hexafluoroisopropylidene) diphthalic anhydride, 1,4,5,8-Naphthalenetetracarboxylic dianhydride, Perylene-3,4,9,10-tetracarboxylic dianhydride, 4,4′-Oxydiphthalic anhydride, 4,4′-(4,4′-Isopropylidenephenoxy)bis(phthalic anhydride), or combinations thereof.

Suitable polyetheramines can be amine-terminated polyethers. Suitable polyethers include: poly(ethyleneglycol) bis(3-aminopropylether) (molecular weight 1500), poly(propyleneglycol) bis(2-aminopropylether) (molecular weight 230), poly(propyleneglycol) bis(2-aminopropylether) (molecular weight 400), poly(propyleneglycol) bis(2-aminopropylether) (molecular weight 2000), poly(propyleneglycol) bis(2-aminopropylether) (molecular weight 4000), poly(propyleneglycol)-block-poly(ethyleneglycol)-block poly(propyleneglycol) bis(2-aminopropylether) (3.5:8.5) (PO:EO) (molecular weight 600), poly(propyleneglycol)-block-poly(ethyleneglycol)-block poly(propyleneglycol) bis(2-aminopropylether) (3.5:15.5) (PO:EO) (mw 900), poly(propyleneglycol)-block-poly(ethyleneglycol)-block poly(propyleneglycol) bis(2-aminopropylether) (3.5:40.5) (PO:EO) (molecular weight 2000), glycerol tris[poly(propylene glycol), amine terminated] ether (molecular weight 3000) or trimethylpropane tris(propylene glycol) amine terminated] ether (molecular weight 440).

Exemplary synthesis routes are described below for the synthesis of polyether-imide polymers. In this embodiment, a polyether containing Jeffamine is reacted with PMDA to obtain a polyether imide polymer:

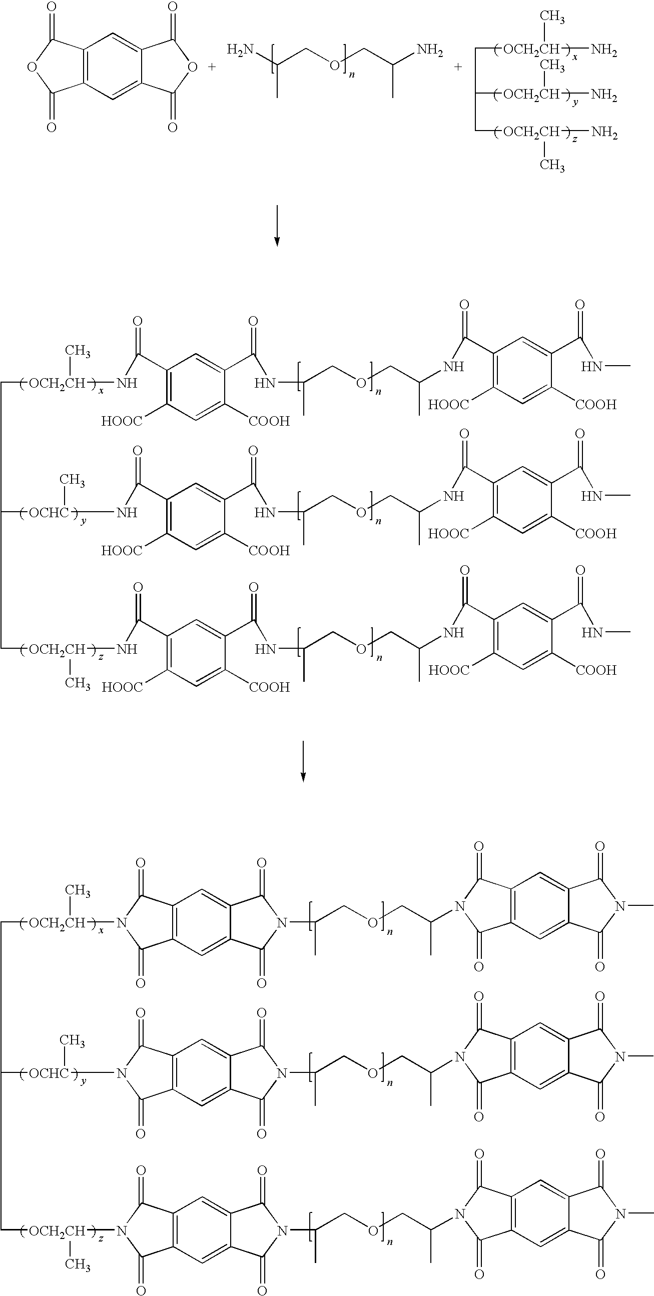

The reaction of amine-terminated polyethers and anhydrides can be carried out neat, or in solvents like DMF, NMP or dimethylacetamide. The temperature of the reaction can be 25° C. to 60° C. or higher. The reaction time can range from about 1 hours to about 72 hours.

In addition to PMDA, a skilled practitioner may use other dianhydrides such as: 3,3′,4,4′-biphenyltetracarboxylic dianhydride, 4,4′-(Hexafluoroisopropylidene) diphthalic, 1,4,5,8-Naphthalenetetracarboxylic dianhydride, Perylene-3,4,9,10-tetracarboxylic dianhydride, 4,4′-Oxydiphthalic anhydride, 4,4′-(4,4′-Isopropylidenephenoxy)bis(phthalic anhydride) and combinations thereof. In a preferred embodiment, the dianhydride is pyromellitic dianhydride.

In an alternative embodiment, the dianhydride may be replaced with a functional dianhydride such as bicyclo[2.2.2]oct-7-ene-2,3,5,6-tetracarboxylic dianhydride (BOTCA), 3,3′,4,4″-benzophenone tetracarboxylic dianhydride, or combinations thereof. The polyether imide material then can be cross-linked using various techniques such as heat, peroxide or in combination with polymerization monomers such as divinyl benzene.

### Process for Making the Polyether Imide Membrane:

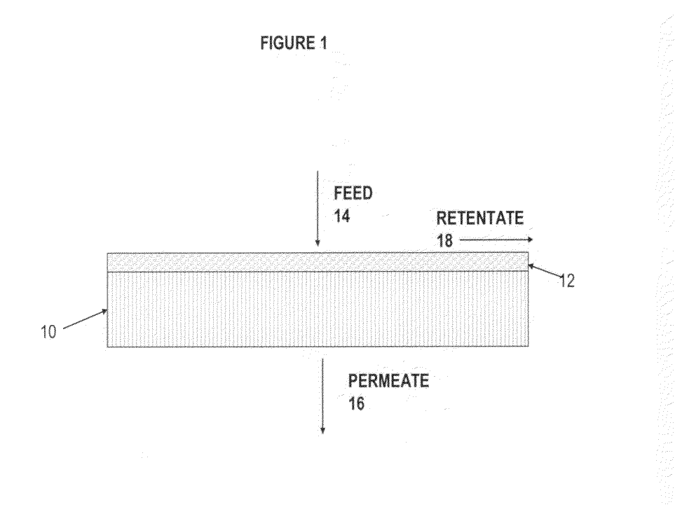

Referring to FIG. 1, there is illustrated a polymer coated porous substrate membrane system in accordance with the present invention. Though not required in all applications of the present invention, a porous substrate may be used for physical support and enhanced membrane integrity. A substrate (10), here shown as disposed under layer (12), comprises a porous material such as Teflon®, for example. Substrate (10) is characterized as comprising a porous material, suitable for physical support of the polymeric membrane detailed hereinafter. The porosity of the substrate is selected based upon the feed materials that it will be used for separating. That is, the pore size of the substrate is selected to provide little or no impedance to the permeation of the materials that are intended to be the permeate of the overall membrane system. It is also preferred that the ceramic substrate is substantially permeable to hydrocarbon liquid such as gasoline, diesel, and naphtha for example. It is also preferred that the pore size distribution is asymmetric in structure, e.g., a smaller pore size coating is supported on a larger pore size inorganic structure.

Non-limiting examples of supported membrane configurations include casting the membrane onto a support material fabricated from materials such as, but not limited to, porous polytetrafluoroethylene (e.g., Teflon®), aromatic polyamide fibers (e.g., Nomex® and Kevlar®), porous metals, sintered metals, porous ceramics, porous polyester, porous nylon, activated carbon fibers, latex, silicones, silicone rubbers, permeable (porous) polymers including polyvinylfluoride, polyvinylidenefluoride, polyurethanes, polypropylenes, polyethylenes, polycarbonates, polysulfones, and polyphenylene oxides, metal and polymer foams (open-cell and closed-cell foams), silica, porous glass, mesh screens, and combinations thereof. Preferably, the polymeric membrane support is selected from polytetrafluoroethylene, aromatic polyamide fibers, porous metals, sintered metals, porous ceramics, porous polyesters, porous nylons, activated carbon fibers, latex, silicones, silicone rubbers, permeable (porous) polymers including polyvinylfluoride, polyvinylidenefluoride, polyurethanes, polypropylenes, polyethylenes, polycarbonates, polysulfones, and polyphenylene oxides and combinations thereof.

Layer (12) comprises the polymer membrane. There are a number of alternative techniques, known to the skilled practitioner, for fabricating the polymer membrane taught herein. In a preferred embodiment, the polymer membrane may be made by casting a solution of the polymer precursor onto a suitable support, such as porous Gortex or a microporous ceramic disc or tube, here shown as substrate (10). The solvent is evaporated and the polymer cured by heating to obtain a dense film having a thickness of typically 10 to 100 microns.

The membrane compositions and configurations of the present invention can also be utilized in both unsupported and supported configurations. A non-limiting example of an unsupported membrane configuration includes casting the membrane on a glass plate and subsequently removing it after the chemical cross-linking reaction is completed.

The membrane compositions and configurations of the present invention can be employed in separation processes that employ a membrane in any workable housing configuration such as, but not limited to, flat plate elements, wafer elements, spiral-wound elements, porous monoliths, porous tubes, or hollow fiber elements.

The membranes described herein are useful for separating a selected component or species from a liquid feed, a vapor/liquid feed, or a condensing vapor feeds. The resultant membranes of this invention can be utilized in both perstractive and pervaporative separation processes.

The membranes of this invention are useful for separating a desired species or component from a feedstream containing at least one alcohol, preferably a hydrocarbon feedstream. In a preferred embodiment, the membrane compositions and configurations above are utilized for the selective separation of aromatics from a hydrocarbon feedstream containing aromatics and non-aromatics and at least one alcohol, typically ethanol.

In another embodiment, the membrane compositions and configurations above are utilized to selectively separate sulfur and nitrogen heteroatoms from a hydrocarbon stream containing sulfur heteroatoms and nitrogen heteroatoms.

In a pervaporative membrane mode, a feed (14) comprising gasoline containing ethanol, for example, is fed to the membrane (12). The aromatic constituents of the gasoline feed preferentially adsorb into and migrate through the membrane (12). A vacuum on the permeate (16) side vaporizes the permeate, which has an increased concentration of aromatics (relative to feed (14)).

Membrane separation will preferentially operate at a temperature less than the temperature at which the membrane performance would deteriorate or the membrane would be physically damaged or chemically modified (e.g. oxidation). For hydrocarbon separations, the membrane temperature would preferably range from about 32° F. to about 950° F. (0 to 510° C.), and more preferably from about 75° F. to about 500° F. (24 to 260° C.).

In still another embodiment, the hydrocarbon feedstream is a naphtha with a boiling range of about 80 to about 450° F. (27 to 232° C.), and contains aromatic and non-aromatic hydrocarbons and at least one alcohol. In a preferred embodiment, the aromatic hydrocarbons are separated from the naphtha feedstream. As used herein, the term naphtha includes thermally cracked naphtha, catalytically cracked naphtha, and straight-run naphtha. Naphtha obtained from fluid catalytic cracking processes (“FCC”) are particularly preferred due to their high aromatic content.

The feed (14) may be heated from about 50° C. to about 200° C., preferably about 80° C. to about 160° C. While feed (140) may be liquid, vapor, or a combination of liquid and vapor, when feed. (14) contacts the membrane (12) it is preferably liquid. Accordingly, the feed side of the membrane may be elevated in pressure from about atmospheric to about 150 psig to selectively maintain feed contacting the membrane in a liquid form. The operating pressure (vacuum) ranges in the permeate zone would preferably be from about atmospheric pressure to about 1.0 mm Hg absolute.

In a preferred embodiment, the permeate is condensed into liquid form, then “swept” by a liquid or vapor sweep stream. The permeate dissolves into the sweep stream and is conducted away by sweep stream flow in order to prevent the accumulation of permeate in the permeate zone.

### EXAMPLES

The below non-limiting examples identify specific polyether imide membranes that were prepared to illustrate this invention. These membranes were subjected to TGA Testing, Ethanol Stability Testing, and Membrane Pervaportion Testing as described below.

### TGA Testing

Single component sorption experiments were performed for these membranes using a thermal gravimetric analyzer (TGA). In this type of experiment polymer films were degassed under flowing helium at 150° C. until reaching a steady weight. The temperature was then lowered to 100° C. and vapor, either toluene or heptane, was introduced at 90% saturation in helium. The mass uptake of the vapor was measured as a function of time until equilibrium was reached. Desorption was achieved by exposing the sample to pure helium at 150° C. until the sample returned to its original weight.

This measurement permits determination of the equilibrium solubility as well as diffusivity of sorbates within a polymer film. When the solubility and diffusivity are known, the ideal selectivity of component A over component B is estimated as the product of solubility and diffusivity of component A divided by the product of solubility and diffusivity of component B. The ideal selectivity determined in this manner can be used as a comparative tool to gauge the potential performance of one polymer over another.

### Ethanol Stability Testing

Approximately 150 mg polymer film was mixed with 3 g of ethanol and the mixture was heated in stainless still vessel at 150° C. for 72 hours. At the end of the test, sample was cooled to room temperature and dried in vacuum at 60° C. The weight loss was determined based on difference between initial and final weight of the polymer film.

### Membrane Pervaporation Testing

Membranes for pervaporation testing were prepared by casting a solution of the polymer precursor onto a suitable support, such as porous Gortex or a microporous ceramic disc or tube. The solvent is evaporated and the polymer cured by heating to obtain a dense film having a thickness of typically 10 to 100 microns.

The pervaporation testing was conducted by circulating a preheated feed, typically consisting of a mixture of equal weight fractions of n-heptane and toluene over the membranes. Ethanol at typically 10 wt % is added to this mixture to evaluate ethanol selectivity and additional testing of stability. The membranes were heated to a temperature of 140° C., or as desired, while maintaining pressure of about 80 psig or higher as required to maintain the feed as liquid while applying a vacuum to the opposing side to facilitate pervaporation of the feed components selectively absorbed by the polymer film. The permeate is condensed from vacuum by using a dry ice trap to determine the pervaporation rate or flux and separation selectivity.

The permeate flux rates were calculated and corrected for the polymer thickness, and typically presented as g-microns/s-m2. A sufficient feed rate is maintained to control the yield of permeate to typically less than 1-2% on feed. Aromatic Selectivity is calculated by comparing the aromatic content of the permeate product (AP), with that in the feed, (AF), and normalizing on the Non-aromatic components in the permeate (NP) relative to the feed (NF): (AP/AF)/(NP/NF). Analogous selectivities can be calculated for ethanol and or other feed components.

### Example 1

### (Comparative Example) Polyethyleneimide (PEI)

The first step is a condensation polymerization of an oligomeric polyethyleneadipate (PEA) diol and pyromellitic anhydride (PMDA). Typically the condensation reaction involves use of an oligomeric aliphatic polyester (PEA) diol and PMDA in the mole ratio of 1:2 to obtain the anhydride reacted prepolymer. The reaction is generally carried out at 160° C. in 2.5 hours without any solvent under nitrogen atmosphere. In the second step, the prepolymer is dissolved in a suitable polar solvent such as dimethyl formamide (DMF). In the DMF solution, one mole of the prepolymer reacts with one mole of methylene di-o-chloroaniline (MOCA) to make a copolymer containing polyamic acid segment and PEA segment in the chain-extension step. The typical mole ratio of the reagents in this step is 1:1 and the reaction temperature can be lower than room temperature (˜15° C. to room temperature). The solvent of the reaction is DMF and additional DMF solvent may be needed to keep the viscosity of the solution low as the viscosity of the solution may increase as a result of a chain-extension reaction. Next set involves reaction of polyamic acid copolymer with diepoxyoctane (DENO). The mole of ratio of the reagent is 1:2 and the reaction can be carried at room temperature for 30-60 minutes.

This solution can be used to prepare polymer membrane by casting (film coating) the solution onto a porous support (e.g., porous Gore-tex teflon) or a glass plate. The thickness can be adjusted by means of a casting knife. The film of the solution from DMF can be prepared and the membrane is dried initially at room temperature and then at higher temperatures (120° C.) and finally cured at much higher temperature (˜160° C.). The room temperature reaction may be removing the solvent. The higher temperature (120° C.) may be for the reaction of diepoxide with pendent carboxylic groups. The curing step may convert the polyamide-ester hard segment to the polyimide hard segment via the imide ring closer with the release of alcohol. In the synthesis with PEA, PMDA, MOCA and diepoxide at a molar ratio of 1:2:1:2, the degree of cross-linking for pendent carboxylic acid groups adjacent to the ester linkages between polyimide hard segments and polyester soft segments is 50%. The amounts of the diepoxide used in the cross-linking is 25%. The amounts of the diepoxide resulting in ester alcohol and free alcohol are 50% and 25%, respectively.

### Schematic Structure of Polyethyleneimide (PEI) Membrane.

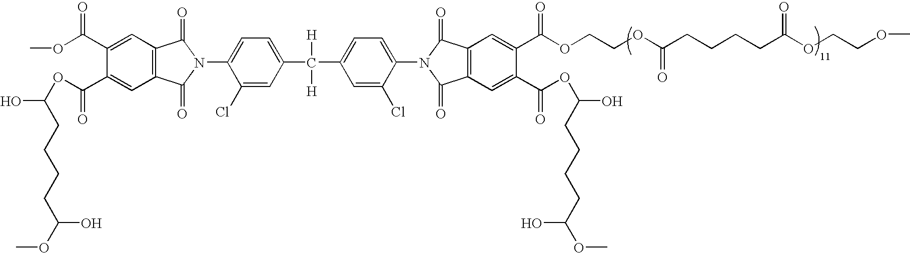

An Ethanol Stability test of the PEI polymer film of this comparative example determined that the film was completely dissolved with 100% wt loss at 150° C. in 36 hours.

### Example 2

### Synthesis of Polyimide Membrane Using Pyromellatic Dianhydride (PMDA) and Trimethylolpropane Tris [Poly (Propylene Glycol), Amine Terminated] Ether (Mw=440)

Pyromellatic dianhydride (PMDA) was crystallized in 1,4-dioxane and dried at 150° C. under vacuum. 3.27 g crystallized PMDA (0.015 mol) was added into a flask with 25 ml N,N-dimethyl acetamide (DMA). After the dianhydride was dissolved completely in DMA, 4.4 g of trimethylolpropane tris[poly(propylene glycol), amine terminated] ether (Mw=440) (0.01 mol) and N,N-dimethylacetamide (10 ml) was added. The trimethylolpropane tris[poly(propylene glycol), amine terminated] ether (Mw=440) was purified by azotropic distillation with toluene and dried at 150° C. under vacuum. Thus the mole ratio of PMDA to triamine was 1:5 to 1. After addition the reaction was stirred at 25° C. for 12 hours and then heat at 135° C.-140 for 4 h. The thick polymer solution was cool down to room temperature. The polymer was used to prepare polyimide films as follows:

A 5 mL polymer solution was poured in aluminum pan. The solvent was evaporated at room temperature and then the polymer film was cured by heating under vacuum at 80° C. for 18 h, 100° C. for 2 h, 120° C. for 2 h, 150° C. for 2 h and 230° C. for 2 h to obtain the dense film. The IR spectrum of the film showed characteristic imide peaks.

An Ethanol Stability test of the polymer film determined that the film was intact and lost only 1.7 wt % at 150° C. in 72 hours.

### Example 3

### Synthesis of Poly Imide Membrane Using Pyromellatic Dianhydride (PMDA), Poly(Propylene Glycol)-Block-Poly(Ethelene Glycol)-Block-Poly(Propylene Glycol) Bis (2-Aminopropylene Ether) (Mw=˜600) and Trimethylolpropane Tris[Poly(Propylene Glycol), Amine Terminated] Ether (Mw=440) in the Mole Ratio of 1.0:0.9:0.1

Pyromellatic dianhydride (PMDA) was crystallized in 1,4-dioxane and dried at 150° C. under vacuum. 2.2 g crystallized PMDA (0.01 mmol) was added into a flask with 22 ml N,N-dimethyl acetamide (DMA) under nitrogen atmosphere with stirring. After the dianhydride was dissolved completely in DMA, 5.4 g poly(propylene glycol)-block-poly(ethelene glycol)-block-poly(propylene glycol) bis(2-aminopropylene ether) (0.009 mol, Mw˜600) was added and the mixture was stirred at room temperature for 2 h at 25° C. Latter added 0.44 g trimethylolpropane tris[poly(propylene glycol), amine terminated] ether (00.009 mol, Mw=440) and the solution was heated at 135° C. for 4 h. The thick polymer solution was cool down to room temperature. The polymer was used to prepare polyimide films as follows:

5 mL polymer solution was poured in aluminum pan. The solvent was evaporated at room temperature and then the polymer film was cured by heating under vacuum at 80° C. for 18 h, 100° C. for 2 h, 120° C. for 2 h, 150° C. for 2 h and 230° C. for 2 h to obtain the dense film. The IR spectrum of the film showed characteristic imide peaks.

TGA testing of the membrane selectivity of the polymer membrane for toluene and heptane was determined to be 6.8.

### Example 4

### Synthesis of Poly Imide Membrane Using Pyromellatic Dianhydride (PMDA), Poly(Propylene Glycol)-Block-Poly(Ethelene Glycol)-Block-Poly(Propylene Glycol) Bis (2-Aminopropylene Ether) (Mw=˜600) and Trimethylolpropane Tris[Poly(Propylene Glycol), Amine Terminated] Ether (Mw=440) in the Mole Ratio of 1.0:0.8:02

Pyromellatic dianhydride (PMDA) was crystallized in 1,4-dioxane and dried at 150° C. under vacuum. 2.2 g crystallized PMDA (0.01 mmol) was added into a flask with 28 ml N,N-dimethyl acetamide (DMA) under nitrogen atmosphere with stirring. After the dianhydride was dissolved completely in DMA, 4.8 g poly(propylene glycol)-block-poly(ethelene glycol)-block-poly(propylene glycol) bis(2-aminopropylene ether) (0.008 mol, Mw˜600) was added and the mixture was stirred at room temperature for 2 h at 25° C. Latter added 0.88 g trimethylolpropane tris[poly(propylene glycol), amine terminated] ether (00.002 mol, Mw=440) and the solution was heated at 135° C. for 4 h. The thick polymer solution was cooled down to room temperature. The polymer was used to prepare polyimide films as follows:

5 mL polymer solution was poured in aluminum pan. The solvent was evaporated at room temperature and then the polymer film was cured by heating under vacuum at 80° C. for 18 h, 100° C. for 2 h, 120° C. for 2 h, 150° C. for 2 h and 230° C. for 2 h to obtain the dense film. The IR spectrum of the film showed characteristic imide peaks.

The TGA testing of the membrane selectivity of the polymer membrane for toluene and heptane was determined as discussed earlier and the selectivity was found to be 7.1.

The Ethanol Stability test of the polymer film determined that the film was intact and lost 14.5 wt % at 150° C. in 72 hours.

### Example 5

### Synthesis of Poly Imide Membrane Using Pyromellatic Dianhydride (PMDA), Poly(Propylene Glycol)-Block-Poly(Ethelene Glycol)-Block-Poly(Propylene Glycol) Bis (2-Aminopropylene Ether) (Mw=˜600) and Trimethylolpropane Tris[Poly(Propylene Glycol), Amine Terminated] Ether (Mw=440) in the Mole Ratio of 1.0:0.5:0.5

Pyromellatic dianhydride (PMDA) was crystallized in 1,4-dioxane and dried at 150° C. under vacuum. 2.2 g crystallized PMDA (0.01 mmol) was added into a flask with 28 ml N,N-dimethyl acetamide (DMA) under nitrogen atmosphere with stirring. After the dianhydride was dissolved completely in DMA, 3 g poly(propylene glycol)-block-poly(ethelene glycol)-block-poly(propylene glycol) bis(2-aminopropylene ether) (0.005 mol, Mw˜600) was added and the mixture was stirred at room temperature for 2 h at 25° C. Latter added 2.2 g trimethylolpropane tris[poly(propylene glycol), amine terminated] ether (00.005 mol, Mw=440) and the solution was heated at 135° C. for 4 h. The thick polymer solution was cool down to room temperature. The polymer was used to prepare polyimide films as follows:

5 mL polymer solution was poured in aluminum pan. The solvent was evaporated at room temperature and then the polymer film was cured by heating under vacuum at 80° C. for 18 h, 100° C. for 2 h, 120° C. for 2 h, 150° C. for 2 h and 230° C. for 2 h to obtain the dense film. The IR spectrum of the film showed characteristic imide peaks.

The TGA testing of the membrane selectivity of the polymer membrane for toluene and heptane was determined to be 6.8.

The Ethanol Stability test of the polymer film determined that the film was intact and lost 14.5 wt % at 150° C. in 72 hours.

### Example 6

### Pervaporation Test of Poly Imide Membrane Using Pyromellatic Dianhydride (PMDA), Poly(Propylene Glycol)-Block-Poly(Ethelene Glycol)-Block-Poly(Propylene Glycol) Bis (2-Aminopropylene Ether) (Mw=˜600) and Trimethylolpropane Tris[Poly(Propylene Glycol), Amine Terminated] Ether (Mw=440) in the Mole Ratio of 1.25:0.5:0.5

Pyromellatic dianhydride (PMDA) was crystallized in 1,4-dioxane and dried at 150° C. under vacuum. 2.73 g crystallized PMDA (0.0125 mmol) was added into a flask with 70 ml dimethyl formamide (DMF) maintained under Drybox nitrogen atmosphere and heated to 40° C., with stirring until dissolved. A second solution was prepared by dissolving 3 g poly(propylene glycol)-block-poly(ethelene glycol)-block-poly(propylene glycol) bis(2-aminopropylene ether) (0.005 mol, Mw˜600 and 2.2 g trimethylolpropane tris[poly(propylene glycol), amine terminated] ether (0.005 mol, Mw=440)) in 15 ml DMF in the Drybox. This was added slowly to the PMDA solution while maintaining 40° C. An additional 5 ml DMF was added and the mixture was stirred for 2 h at 40° C. The solution was heated to 60° C. for 15 minutes then to 70° C. and an additional 15 ml DMF added. The clear, thick polymer solution was cooled down to room temperature. This polyimide-polyether polymer solution was used to prepare polyimide membrane film as follows:

An 5 nm porosity gamma alumina surface asymetrically porous ceramic alumina tube (Kyocera), nominally 3 mm OD×60 mm long having a surface area of ˜6 cm2 was coated with the polyimide-polyether solution described. The tube was pre-dried in air at 150° C. The ends of the tube were capped and the tube immersed in the polymer solution for 15 minutes. The coated tube was dried with nitrogen flow overnight at room temperature followed heating from 30° C. to 150° C. at 2° C./minute and holding at 150° C. for 60 minutes. The cured polymer coating weight was 4.8 mg. The tube was tested for coating integrity by evacuating to 10 kPa and isolating. The pressure increased to 22 kPa vacuum in 5 minutes.

The polyimide-polyether coated tube membrane was evaluated for pervaporation separation of a feed containing 10 wt % ethanol, 45 wt % n-heptane and 45 wt % toluene. The tube was mounted in a coaxial holder. Preheated, pressurized feed was directed along the outside of the tube at 140° C., 550 kPag and ˜500 ml/minute recycle rate and 1 ml/minute fresh feed makeup rate. A vacuum of ˜5 torr was applied to the inside of the tube by mechanical vacuum pump through a dry-ice trap used to condense all permeate.

An initial permeate flux rate of 7.7 g/s-m2 was obtained at the conditions noted, corresponding to 36.6 wt % yield on feed. The permeate composition was determined to be 24.5 wt % ethanol, 27.4 wt % n-heptane and 48.1 wt % toluene.

The temperature was decreased to 80° C. resulting in a lower permeate flux rate of 3.2 g/s-m2. Yield decreased to 15.1 wt % on feed. The permeate composition was determined to be 28.6 wt % ethanol, 30.4 wt % n-heptane and 40.9 wt % toluene.

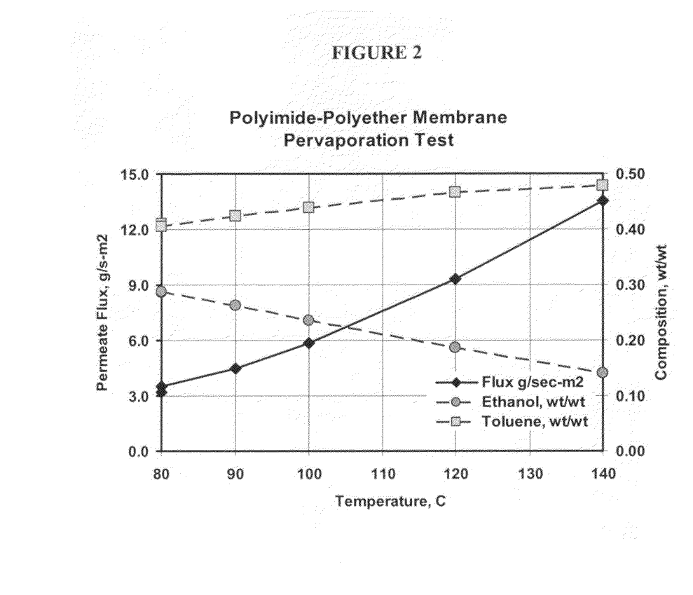

As shown in FIG. 2, as temperature increases, the selectivity to toluene improves, while at lower temperatures ethanol is favored.

The results demonstrate the polyimide-polyether polymer membrane of the invention to be selective aromatics (toluene) and ethanol over aliphatics (n-heptane) in feed mixtures over a range of useful temperatures.

1. A membrane for aromatics separation comprising a polyether amine reacted with an dianhydride and formed into a membrane, wherein said membrane selectivity separates aromatics from a hydrocarbon stream containing aromatics and aliphatics and at least one alcohol.

2. The membrane of claim 1 wherein said polyetheramine comprises polyethylene oxide, polypropylene oxide, or a combination thereof.

3. The membrane of claim 2 wherein said dianhydride is selected from the group consisting essentially of pyromellitic dianhydride (PMDA), 3,3′,4,4′-biphenyltetracarboxylic dianhydride, 4,4′-(Hexafluoroisopropylidene) diphthalic anhydride, 1,4,5,8-Naphthalenetetracarboxylic dianhydride, Perylene-3,4,9,10-tetracarboxylic dianhydride, 4,4′-Oxydiphthalic anhydride, 4,4′-(4,4′-Isopropylidenephenoxy)bis(phthalic anhydride), or combinations thereof.

4. The membrane of claim 3 wherein the membrane is a pervaporation membrane or a perstraction membrane.

5. The membrane of claim 4 wherein the pervaporation membrane has a selectivity of greater than about 3.0.

6. The membrane of claim 5 wherein the selectivity is greater than about 4.0.

7. The membrane of claim 6 wherein the selectivity is greater than about 5.0.

8. The membrane of claim 2 or 3 wherein said polyetheramine is selected from the group consisting essentially of:
poly(ethyleneglycol) bis(3-aminopropylether) (molecular weight 1500), poly(propyleneglycol) bis(2-aminopropylether) (molecular weight 230), poly(propyleneglycol) bis(2-aminopropylether) (molecular weight 400), poly(propyleneglycol) bis(2-aminopropylether) (molecular weight 2000), poly(propyleneglycol) bis(2-aminopropylether) (molecular weight 4000), poly(propyleneglycol)-block-poly(ethyleneglycol)-block poly(propyleneglycol) bis(2-aminopropylether) (3.5:8.5) (PO:EO) (molecular weight 600), poly(propyleneglycol)-block-poly(ethyleneglycol)-block poly(propyleneglycol) bis(2-aminopropylether) (3.5:15.5) (PO:EO) (mw 900), poly(propyleneglycol)-block-poly(ethyleneglycol)-block poly(propyleneglycol) bis(2-aminopropylether) (3.5:40.5) (PO:EO) (molecular weight 2000), glycerol tris[poly(propylene glycol), amine terminated] ether (molecular weight 3000) or trimethylpropane tris(propylene glycol) amine terminated] ether (molecular weight 440), or combinations thereof.

9. The membrane of claim 2 wherein said dianhydride is a functional dianhydride comprising bibcyclo[2.2.2]oct-7ene-2,3,5,6-tetracarboxylic dianhydride (BOTCA), 3,3′,4,4″-benzophenone tetracarboxylic dianhydride, or combinations thereof.

10. A process for separating aromatics from aliphatics in a hydrocarbon feed containing at least one alcohol, comprising:
a) forming a membrane film comprising a polyetheramine reacted with a dianhydride or a functional dianhydride,
b) contacting a first side of the membrane film with the alcohol containing hydrocarbon feed, said membrane preferentially absorbing aromatics over aliphatics,
c) extracting permeate from a second side of the membrane that is higher in aromatics than the feed.

11. The membrane of claim 8 wherein said membrane is a polymeric membrane supported by a porous substrate.

12. The membrane of claim 10 wherein said porous membrane is selected from the group consisting essentially of polytetrafluoroethylene, aromatic polyamide fibers, porous metals, sintered metals, porous ceramics, porous polyester, porous nylon, activated carbon fibers, latex, silicones, silicone rubbers, polyvinylfluoride, polyvinylidenefluoride, polyurethanes, polypropylenes, polyethylenes, polycarbonates, polysulfones, and polyphenylene oxides, metal and polymer foams, silica, porous glass, mesh screens, and combinations thereof.

13. The membrane of claim 8 wherein the porous membrane is selected from the group consisting essentially of: polytetrafluoroethylene, aromatic polyamide fibers, porous metals, sintered metals, porous ceramics, porous polyesters, porous nylons, activated carbon fibers, latex, silicones, silicone rubbers, polyvinylfluoride, polyvinylidenefluoride, polyurethanes, polypropylenes, polyethylenes, polycarbonates, polysulfones, and polyphenylene oxides and combinations thereof.
